(19) United States
(12) Patent Application Publication
(10) Pub. No.: US 2024/0028029 A1
(43) Pub. Date: Jan. 25, 2024

(54) OPERATOR MANAGEMENT SYSTEM, OPERATOR MANAGEMENT METHOD, AND NON-TRANSITORY COMPUTER READABLE RECORDING MEDIUM

(71) Applicant: TOYOTA JIDOSHA KABUSHIKI KAISHA, Toyota-shi Aichi-ken (JP)

(72) Inventors: Narihito Yamazato, Koto-ku Tokyo-to (JP); Koji Taguchi, Sagamihara-shi Kanagawa-ken (JP)

(73) Assignee: TOYOTA JIDOSHA KABUSHIKI KAISHA, Toyota-shi Aichi-ken (JP)

(21) Appl. No.: 18/338,507

(22) Filed: Jun. 21, 2023

(30) Foreign Application Priority Data
Jul. 25, 2022 (JP) 2022-117935

(51) Int. Cl. G05D 1/00

(52) U.S. Cl. CPC G05D 1/0027; G05D 2201/0213

(57) ABSTRACT

An operator management system for managing allocation of a plurality of remote assistance operators to a plurality of vehicles transmitting a remote assistance request is proposed. The operator management system is configured to execute setting an allocation priority corresponding to contents of the remote assistance request for each of the plurality of vehicles, and reassigning a remote assistance operator assigned to a second vehicle to a first vehicle when the number of the plurality of vehicles is larger than the number of the plurality of remote assistance operators and when the allocation priority of the first vehicle is higher than the allocation priority of the second vehicle, the first vehicle being one of the plurality of vehicles to which any remote assistance operator is not assigned, the second vehicle being one of the plurality of vehicles to which one of the plurality of remote assistance operators is assigned.

### CROSS-REFERENCE TO RELATED APPLICATION

The present application claims priority under 35 U.S.C. § 119 to Japanese Patent Application No. 2022-117935, filed Jul. 25, 2022, the contents of which application are incorporated herein by reference in their entirety.

### BACKGROUND

### Technical Field

The present disclosure relates to a technique for managing allocation of a plurality of remote assistance operators to a plurality of vehicles transmitting a remote assistance request.

### Background Art

In an autonomous vehicle which travels in accordance with a driving plan, a technique is being considered in which the autonomous vehicle transmits a remote assistance request to a remote assistance operator at a remote location when the autonomous vehicle encounters or is likely to encounter a driving decision which an autonomous driving system is not good at. Such technique, by the remote assistance operator appropriately making the driving decision, makes it possible for the autonomous vehicle to avoid stopping autonomous driving or falling into a dangerous situation and smoothly continue the autonomous driving.

Patent Literature 1 discloses a control device comprising a generation unit that generates priority information showing a priority for a plurality of autonomous driving operations, a control unit that determines an autonomous driving operation from the plurality of autonomous driving operations based on the priority information and performs autonomous driving, and an output unit that outputs an operation request of a vehicle when the control unit cannot determine the autonomous driving operation.

In addition, there is the following Patent Literatures 2 to 5 as documents showing the technical level of the technical field according to the present disclosure.

### LIST OF RELATED ART

Patent Literature 1: JP 2018/151908 A
Patent Literature 2: JP 2018/142265 A
Patent Literature 3: JP 2019/185279 A
Patent Literature 4: JP 2019/185451 A
Patent Literature 5: JP 2019/021200 A

### SUMMARY

When a plurality of autonomous vehicles transmits remote assistance requests, a plurality of remote assistance operators is required. On the other hand, from the viewpoint of human cost, the number of remote assistance operators is generally smaller than the number of the plurality of autonomous vehicles. Therefore, when the number of autonomous vehicles transmitting the remote assistance request increases, the number of remote assistance operators may be insufficient.

The assignment of remote assistance operators is conventionally performed in the order in which the remote assistance request is transmitted. Therefore, when the number of remote assistance operators is insufficient, the autonomous vehicle that has transmitted the remote assistance request late waits for the start of remote assistance regardless of the content of the remote assistance request. However, depending on the content of the remote assistance request, it may be more appropriate, from the viewpoint of speeding up emergency response or smoothing traffic flow, to first process the autonomous vehicle that has transmitted the remote assistance request late.

In the view of the above problem, an object of the present disclosure is to provide a technique for managing assignment of a plurality of remote assistance operators to a plurality of vehicles transmitting a remote assistance request, the technique being capable of appropriately assigning the plurality of remote assistance operators when the number of the plurality of vehicles is larger than the number of the plurality of remote assistance operators.

A first disclosure is directed to an operator management system for managing allocation of a plurality of remote assistance operators to a plurality of vehicles transmitting a remote assistance request.

The operator management system according to the first disclosure comprises:
one or more processors; and
a memory storing executable instructions configured to cause the one or more processors to execute:
   setting an allocation priority corresponding to contents of the remote assistance request for each of the plurality of vehicles; and
   reassigning a remote assistance operator assigned to a second vehicle to a first vehicle when the number of the plurality of vehicles is larger than the number of the plurality of remote assistance operators and when the allocation priority of the first vehicle is higher than the allocation priority of the second vehicle, the first vehicle being one of the plurality of vehicles to which any remote assistance operator is not assigned, the second vehicle being one of the plurality of vehicles to which one of the plurality of remote assistance operators is assigned.

A second disclosure is directed to an operator management system including the following features with respect to the operator management system according to the first disclosure.

The setting the allocation priority includes updating the allocation priority for each of the plurality of vehicles in response to newly acquiring the remote assistance request.

A third disclosure is directed to an operator management system including the following features with respect to the operator management system according to the first or second disclosure.

The remote assistance request includes one or more assistance request items, and
the setting the allocation priority includes:
   calculating an assistance priority for each of the one or more assistance request items; and
   setting the allocation priority based on the assistance priority.

A fourth disclosure is directed to an operator management system including the following features with respect to the operator management system according to the third disclosure.

The setting the allocation priority includes updating the allocation priority in response to a portion of the one or more assistance request items being processed by the remote assistance operator.

A fifth disclosure is directed to an operator management system including the following features with respect to the operator management system according to the fourth disclosure.

Each of the plurality of vehicles is an autonomous vehicle traveling in accordance with a driving plan which is a combination of a plurality of driving decisions, and
each of the plurality of vehicles is configured to transmit, as the remote assistance request, the driving plan in response to the one or more assistance request items being added to the plurality of driving decisions.

A sixth disclosure is directed to an operator management method for managing, by a computer, allocation of a plurality of remote assistance operators to a plurality of vehicles transmitting a remote assistance request.

The operator management method according to the sixth disclosure comprises:
setting an allocation priority corresponding to contents of the remote assistance request for each of the plurality of vehicles; and
reassigning a remote assistance operator assigned to a second vehicle to a first vehicle when the number of the plurality of vehicles is larger than the number of the plurality of remote assistance operators and when the allocation priority of the first vehicle is higher than the allocation priority of the second vehicle, the first vehicle being one of the plurality of vehicles to which any remote assistance operator is not assigned, the second vehicle being one of the plurality of vehicles to which one of the plurality of remote assistance operators is assigned.

A seventh disclosure is directed to an operator management program for managing allocation of a plurality of remote assistance operators to a plurality of vehicles transmitting a remote assistance request.

The operator management program according to the seventh disclosure, when executed by a computer, causes the computer to execute:
setting an allocation priority corresponding to contents of the remote assistance request for each of the plurality of vehicles; and
reassigning a remote assistance operator assigned to a second vehicle to a first vehicle when the number of the plurality of vehicles is larger than the number of the plurality of remote assistance operators and when the allocation priority of the first vehicle is higher than the allocation priority of the second vehicle, the first vehicle being one of the plurality of vehicles to which any remote assistance operator is not assigned, the second vehicle being one of the plurality of vehicles to which one of the plurality of remote assistance operators is assigned.

According to the present disclosure, the allocation priority is set or updated for each of the plurality of vehicles in accordance with the contents of the remote assistance request. And when the number of the plurality of vehicles is larger than the number of the plurality of remote assistance operators and when the allocation priority of the first vehicle to which any remote assistance operator is not assigned is higher than that of the second vehicle to which the remote assistance operator is assigned, the remote assistance operator assigned to the second vehicle is assigned to the first vehicle. It is thus possible to assign the plurality of remote assistance operators such that a vehicle having a high degree of urgency of remote assistance is preferentially processed. As a result, it is possible to appropriately assign the plurality of remote assistance operators based on the viewpoint of speeding up emergency response, smoothing traffic flow, and the like.

### BRIEF DESCRIPTION OF DRAWINGS

FIG. 1 is a conceptual diagram for explaining an outline of an operator management system according to the present embodiment;

FIG. 2 is a conceptual diagram showing an example of a driving plan;

FIG. 3 is a conceptual diagram for explaining an outline of an operator management system function provided by the operator management system according to the present embodiment;

FIG. 4 is a conceptual diagram for explaining an outline of the operator management system function provided by the operator management system according to the present embodiment;

FIG. 5 is a conceptual diagram for explaining an outline of the operator management system function provided by the operator management system according to the present embodiment;

FIG. 6 is a block diagram showing a configuration of a vehicle according to the present embodiment;

FIG. 7 is a block diagram showing a configuration of processes executed in the vehicle according to the present embodiment;

FIG. 8 is a block diagram showing a configuration of a management server according to the present embodiment;

FIG. 9 is a block diagram showing a configuration of processes executed in the management server according to the present embodiment;

FIG. 10 is a block diagram showing a configuration of a remote assistance apparatus according to the present embodiment;

FIG. 11 is a block diagram showing a configuration of processes executed in the remote assistance apparatus according to the present embodiment;

FIG. 12 is a sequence diagram showing processes executed in the vehicle according to the present embodiment;

FIG. 13 is a sequence diagram showing processes executed in the management server according to the present embodiment;

FIG. 14 is a sequence diagram showing processes executed in the management server according to the present embodiment;

FIG. 15 is a sequence diagram showing processes executed in the remote assistance apparatus according to the present embodiment; and

FIG. 16 is a sequence diagram showing processes executed in the remote assistance apparatus according to the present embodiment.

### EMBODIMENTS

### 1. Outline

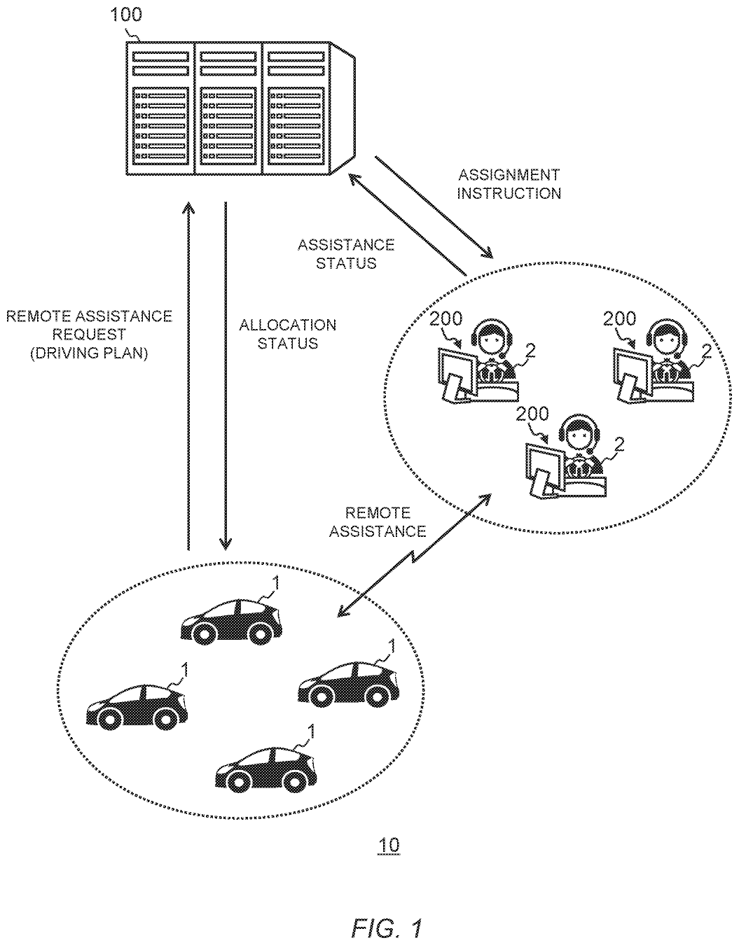

The following will describe an outline of an operator management system according to the present embodiment. FIG. 1 is a conceptual diagram for explaining an outline of an operator management system 10 according to the present embodiment. The operator management system 10 provides a function (hereinafter also referred to as an “operator management function”) of managing assignment of a plurality of remote assistance operators 2 to a plurality of vehicles 1 transmitting a remote assistance request.

Each of the plurality of vehicles 1 is typically an autonomous vehicle. In this case, each of the plurality of vehicles 1 transmits the remote assistance request when the vehicle encounters or is likely to encounter a driving decision which an autonomous driving system is not good at. Each of the plurality of vehicles 1 requests the driving decision from the remote assistance operator 2 by the remote assistance request. The driving decision requested of the remote assistance operator 2 is, for example, timing in a case where lane change is performed or a case where merging is performed at a merging point, adjustment of a parking position in a case where parking is performed, post-action in a case where it is confirmed that the vehicle running out into a road shoulder, or the like. Hereinafter, such driving decision requested of the remote assistance operator 2 in the remote assistance request is also referred to as an “assistance request item”. Note that the remote assistance request may include two or more assistance request items.

Each of the plurality of remote assistance operators 2 corresponds to a remote assistance apparatus 200. The remote assistance apparatus 200 connects to and communicates with the vehicle 1 to be a target of remote assistance. The connection between the remote assistance apparatus 200 and the vehicle 1 may be realized via a mobile communication network and the Internet. In addition, the remote assistance apparatus 200 has a function of notifying the remote assistance operator 2 of the situation of the target vehicle (contents of the remote assistance request, images captured by in-vehicle camera, surrounding environment, vehicle state, and the like) and a function of receiving an input of the driving decision of the remote assistance operator 2. That is, the remote assistance operator 2 confirms the situation of the vehicle 1 from the notification of the remote assistance apparatus 200 and inputs the driving decision to the remote assistance apparatus 200 to perform remote assistance of the vehicle 1.

In the operator management system 10 according to the present embodiment, the operator management function is realized by the management server 100. The management server 100 is configured to be able to communicate with each of the plurality of remote assistance apparatuses 200 corresponding to the plurality of operators 2. And the management server 100 is configured to be able to communicate with each of the plurality of vehicles 1. For example, the management server 100 and each of the plurality of remote assistance apparatuses 200 are connected to the Internet via a communication cable. And the management server 100 and each of the plurality of vehicles 1 are connected to the Internet via a mobile communication network. Alternatively, the management server 100 and each of the plurality of remote assistance apparatuses 200 may be connected to each other via a local area network.

The management server 100 determines allocation of the plurality of remote assistance operators 2 to the plurality of vehicles 1 based on the remote assistance requests acquired from the plurality of vehicles 1 and an assistance status of the plurality of remote assistance operators 2. The assistance status is acquired from each remote assistance apparatus 200. And the assistance status includes at least information regarding whether or not the corresponding remote assistance operator 2 is performing remote assistance (whether or not the corresponding remote assistance operator 2 is assignable). The assistance status may further include information regarding a status of processing the remote assistance request. For example, when the remote assistance request includes two or more assistance request items, the assistance status may include information regarding whether or not each of the two or more assistance request items is processed.

The management server 100 gives an assignment instruction to the remote assistance apparatus 200 corresponding to each of the plurality of remote assistance operators 2 based on the determined allocation. The assignment instruction includes at least information for specifying the vehicle 1 to be a target of remote assistance. For example, the assignment instruction includes information of a vehicle ID for identifying the target vehicle 1. The remote assistance apparatus 200 starts communication with the vehicle 1 to be a target of the remote assistance in accordance with the assignment instruction.

The management server 100 transmits the allocation status to the plurality of vehicles 1. The allocation status includes, for example, information regarding an assignment result showing whether or not the assignment of the remote assistance operator 2 for the transmitted remote assistance request is successful. It makes it possible for each of the plurality of vehicles 1 to acquire a response status of remote assistance with respect to the transmitted remote assistance request. Each of the plurality of vehicles 1 may be configured to execute an appropriate process in accordance with the allocation status.

For example, each of the plurality of vehicles 1 may be configured to start communication with the remote assistance apparatus 200 in response to receiving an assignment result showing that the assignment of the remote assistance operator 2 is successful. Also, for example, each of the plurality of vehicles 1 may be configured to start traveling control for ensuring safety and smooth surrounding traffic flow in response to receiving an assignment result showing that the remote assistance operator 2 is insufficient and the allocation is pending.

The operator management system 10 according to the present embodiment is configured as described above. Note that, when each of the plurality of vehicles 1 is an autonomous vehicle, it is conceivable that each of the plurality of vehicles 1 travels in accordance with a driving plan which is a combination of a plurality of driving decisions. In this case, each of the plurality of vehicles 1 may be configured to transmit the driving plan as the remote assistance request in response to one or more assistance request items being added to the plurality of driving decisions related to the driving plan. Further, each of the plurality of vehicles 1 may be configured to transmit the driving plan even in a case where some assistance request items are withdrawn due to a change in a surrounding traffic situation or a recognition situation after transmitting the driving plan as the remote assistance request. With this configuration, it is possible to integrally handle the remote assistance request and the driving plan. Consequently, it is possible to realize a system with a simple configuration.

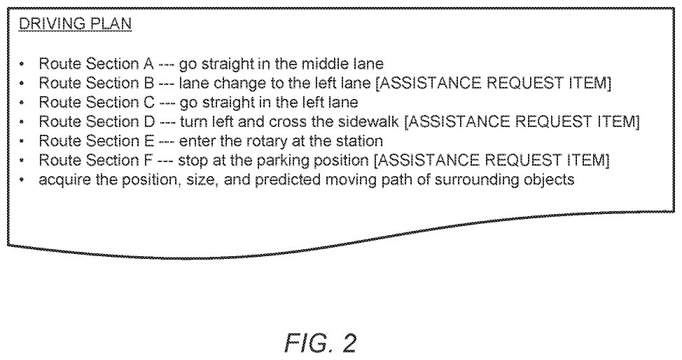

FIG. 2 is a conceptual diagram showing an example of the driving plan. Typically, the driving plan instructs a plurality of driving decisions within a range of a certain distance from the position of the vehicle 1 based on information detected by a sensor or the like. The driving plan may be updated every predetermined control cycle. That is, while the vehicle 1 is traveling, the driving plan instructs the driving decision within the range of the certain distance from the position of the vehicle 1 every moment. In the example shown in FIG. 2, the driving plan includes three assistance request items as the driving decisions in the road section B, the road section D, and the road section F. In this way, the driving plan can be treated as the remote assistance request.

The feature of the operator management function provided by the operator management system 10 according to the present embodiment is setting an allocation priority corresponding to contents of the remote assistance request for each of the plurality of vehicles 1 and changing the allocation of the plurality of remote assistance operators 2 based on the allocation priority of each of the plurality of vehicles 1.

The allocation priority of each of the plurality of vehicles 1 can be calculated by the management server 100 as follows. Hereinafter, a case in which the allocation priority of one of the plurality of vehicles 1 is calculated will be described.

First, the management server 100 calculates an assistance priority for the one or more assistance request items included in the remote assistance request transmitted by the vehicle 1. The assistance priority is a degree of urgency of the assistance request item. The degree of urgency may be determined by using safety or smoothness of surrounding traffic flow as an index. The assistance priority may be represented by a numerical value. Note that, when the remote assistance request includes two or more assistance request items, the management server 100 calculates the assistance priority for each assistance request item.

The management server 100 may be configured to calculate pre-stored assistance priority for each assistance request item. For example, the management server 100 stores the assistance priority for the assistance request item as shown in Table 1 below. In this case, the management server 100 calculates a numerical value corresponding to the assistance request item in Table 1 as the assistance priority. For example, when the assistance request item is a lane change, the calculated assistance priority is 5. Also, for example, when the vehicle 1 transmits the driving plan shown in FIG. 2 as the remote assistance request, the assistance priorities calculated for the three assistance request items are 5 (lane change), 10 (crossing a sidewalk), and 8 (adjustment of a parking position).

TABLE 1

| ASSISTANCE REQUEST ITEM | ASSISTANCE PRIORITY |
|---|---|
| Possibility of a serious accident | 50 |
| Possibility of a minor accident | 30 |
| Running out into an oncoming lane | 10 |
| Running out into a road shoulder | 10 |
| Lane change | 5 |
| Stop due to obstacle | 5 |
| Start vehicle | 10 |
| Adjustment of a parking position | 8 |
| Crossing a sidewalk | 10 |

Next, the management server 100 calculates the allocation priority of the vehicle 1 based on the calculated assistance priority. When the remote assistance request includes only one assistance request item, the management server 100 may set the calculated assistance priority for the assistance request item as the allocation priority of the vehicle 1. Further, when the remote assistance request includes two or more assistance request items, the management server 100 may set the highest assistance priority among the assistance priorities calculated for each of the two or more assistance request items as the allocation priority of the vehicle 1. For example, when the vehicle 1 transmits the driving plan shown in FIG. 2 as the remote assistance request, the management server 100 may set the allocation priority of the vehicle 1 to 10.

In this way, the management server 100 can calculate the allocation priority for each of the plurality of vehicles 1. The allocation priority can also be considered as a degree of urgency regarding remote assistance of the vehicle 1.

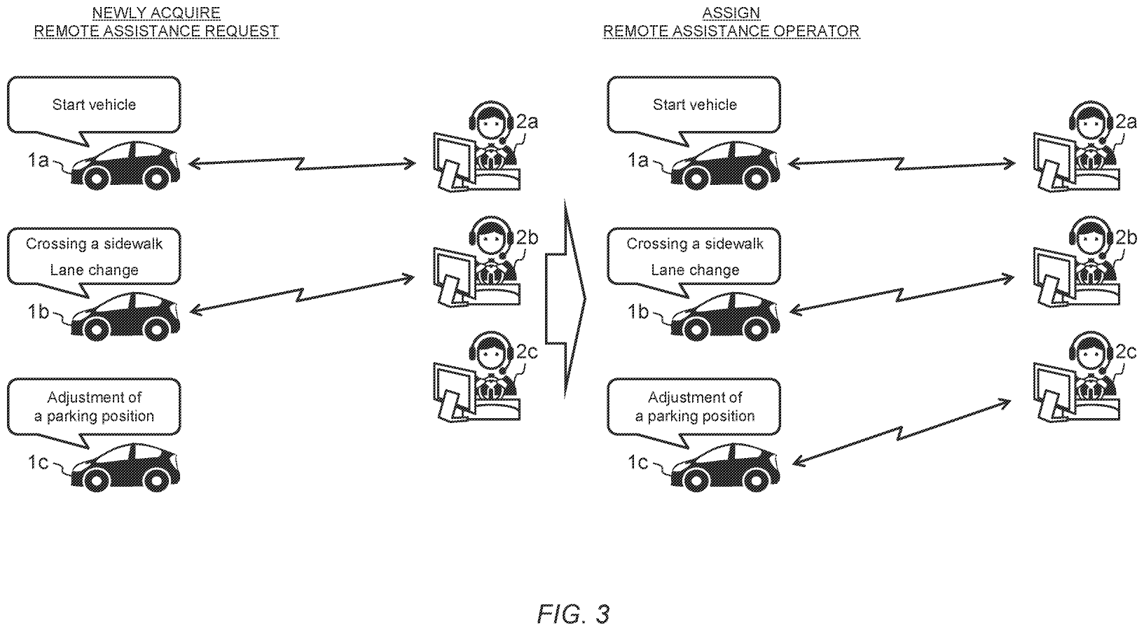

The following will describe an outline of the operator management function provided by the operator management system 10 with reference to FIGS. 3 to 5. In the following description, it is assumed that the number of the plurality of remote assistance operators 2 is three.

First, refer to FIG. 3. FIG. 3 shows a case where a remote assistance request is newly acquired when there is an assignable operator among the plurality of remote assistance request operators 2. In FIG. 3, symbols a, b, and c are added to reference letters in order to distinguish the plurality of remote assistance operators 2 and the plurality of vehicles 1 from each other.

In FIG. 3, when a remote assistance operator 2c is assignable, a vehicle 1c newly transmits a remote assistance request. In this case, the management server 100 assigns the remote assistance operator 2c to the vehicle 1c.

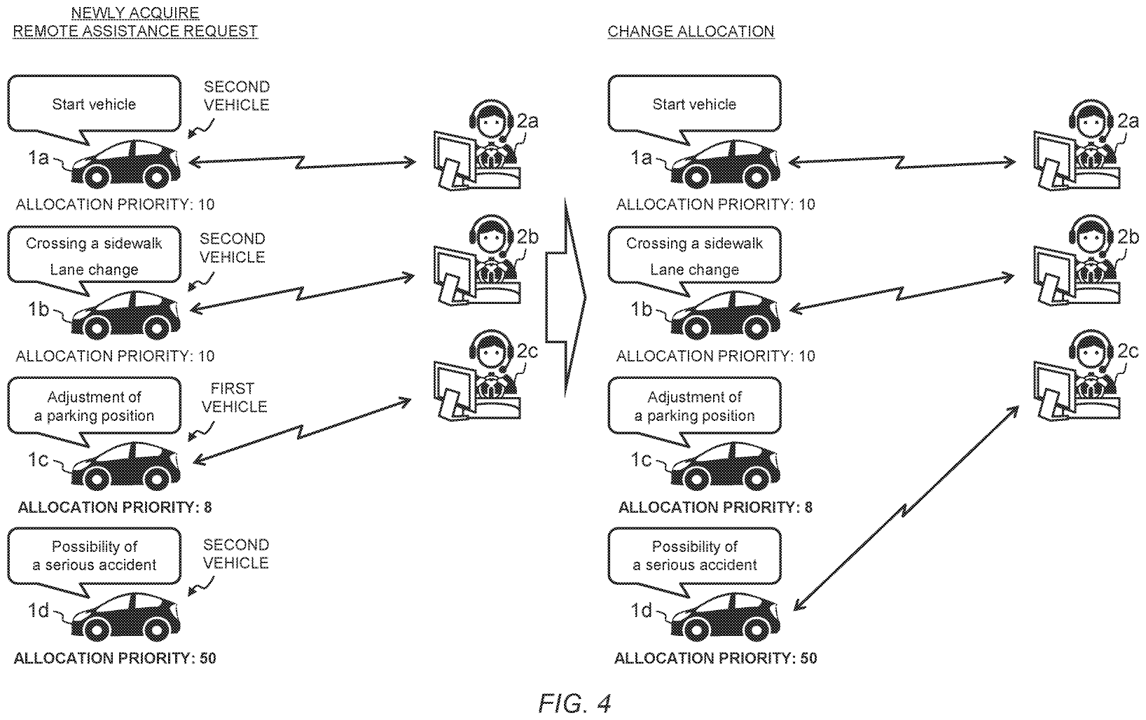

Next, refer to FIG. 4. FIG. 4 shows a case where a remote assistance request is newly acquired when there is no assignable operator among the plurality of remote assistance operators 2 after the allocation shown in FIG. 3. That is, this is a case where the number of the plurality of vehicles 1 is larger than the number of the plurality of remote assistance operators 2. In FIG. 4, the vehicle 1d has newly transmits a remote assistance request. However, since there is no assignable operator among the plurality of remote assistance operators 2, it is not possible to simply perform assignment as shown in FIG. 3.

Then, as shown in FIG. 4, the management server 100 updates the allocation priority for each of the plurality of vehicles 1. And the management server 100 reassigns a remote assistance operator assigned to a second vehicle to a first vehicle when the allocation priority of the first vehicle is higher than the allocation priority of the second vehicle. Here, the first vehicle is one of the plurality of vehicles 1 to which any remote assistance operator is not assigned. And the second vehicle is one of the plurality of vehicles 1 to which one of the plurality of remote assistance operators 2 is assigned. In the example shown in FIG. 4, the allocation priority of the vehicle 1d (first vehicle) is higher than the allocation priority of the vehicle 1c (second vehicle). Therefore, the management server 100 changes the allocation of the plurality of remote assistance operators 2 such that the remote assistance operator 2c, which is assigned to the vehicle 1c, is reassigned to the vehicle 1d.

Note that, when there are two or more second vehicles, the target to which the assignment of the remote assistance operator 2 is changed may be the second vehicle having the lowest allocation priority. Even in a case where the target to which the assignment of the remote assistance operator 2 is changed is not the second vehicle having the lowest allocation priority, by sequentially repeating of reassigning as described above, the same allocation can be achieved. In addition, when there are two or more first vehicles having the same allocation priority, the management server 100 may be configured to select the first vehicle to which the remote assistance operator 2 is assigned based on a some index. Examples of the index include the length of a period in which the assignment is not performed, the narrowness of the road width on which the vehicle 1 is located, the degree of deviation from the schedule, and the like. By adopting such a configuration, it is possible to select the first vehicle having a higher necessity of remote assistance in accordance with the situation of the vehicle 1.

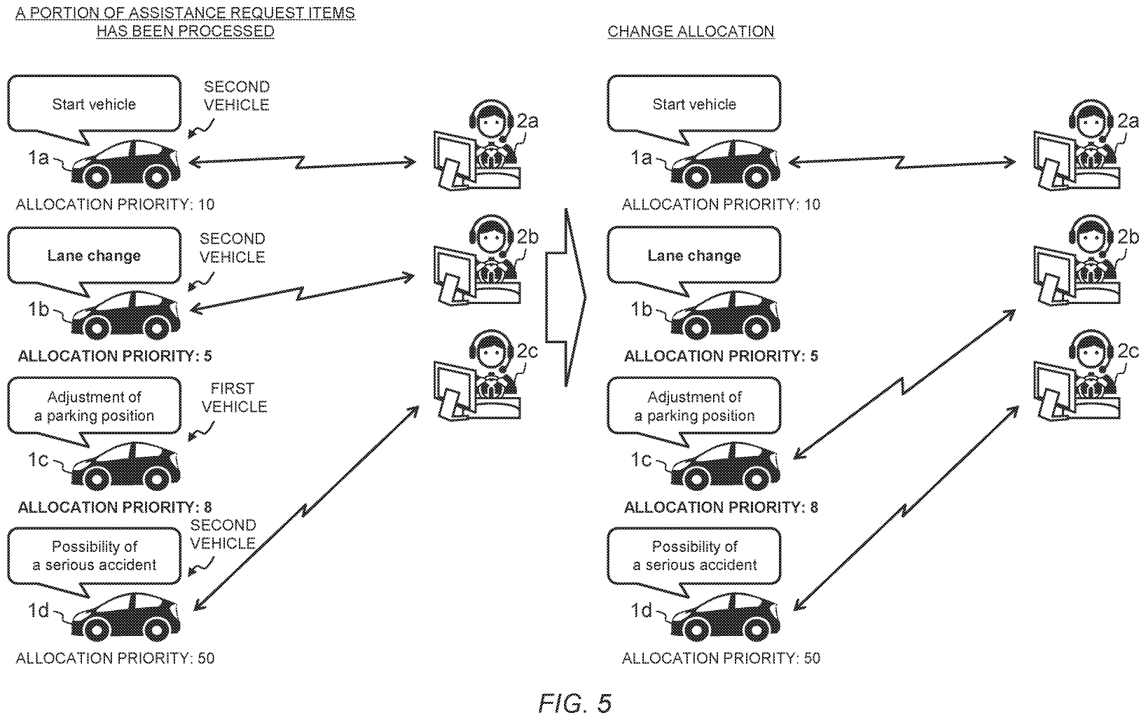

Next, refer to FIG. 5. FIG. 5 shows a case where a portion of the one or more assistance request items regarding any one of the plurality of vehicles 1 is processed after the change of the assignment shown in FIG. 4. In FIG. 5, “crossing a sidewalk” which is the assistance request item regarding the vehicle 1b is processed. In this case, the management server 100 updates the allocation priority for each of the plurality of vehicles 1. Thus, as shown in FIG. 5, the allocation priority of the vehicle 1b is changed from 10 to 5. And the management server 100 reassigns a remote assistance operator assigned to a second vehicle to a first vehicle when the allocation priority of the first vehicle is higher than the allocation priority of the second vehicle. In FIG. 5, since the allocation priority of the vehicle 1c (first vehicle) is higher than the allocation priority of the vehicle 1b (second vehicle). Therefore, the management server 100 changes the allocation of the plurality of remote assistance operators 2 such that the remote assistance operator 2b, which is assigned to the vehicle 1b, is reassigned to the vehicle 1c.

### 2. Configuration

The following will describe configurations of the vehicle 1, the management server 100, and the remote assistance apparatus 200 in the operator management system 10 according to the present embodiment. In the following description, it is assumed that the vehicle 1 is an autonomous vehicle that transmits a driving plan as the remote assistance request.

### 2-1. Autonomous Vehicle

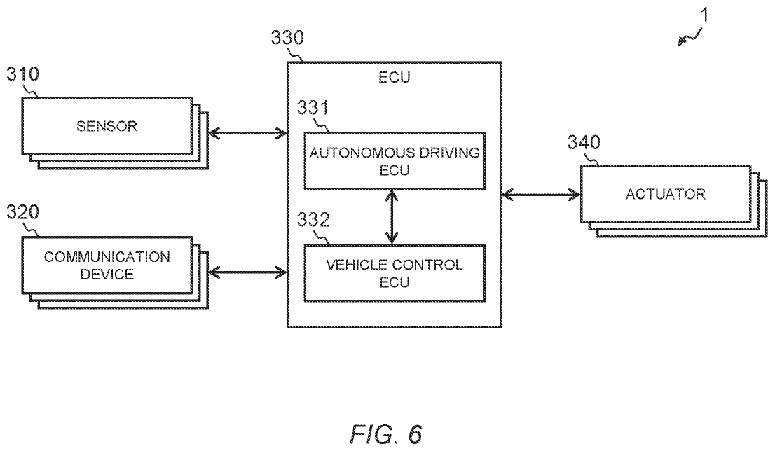

First, a configuration of the vehicle 1 (autonomous vehicle) will be described. FIG. 6 is a block diagram showing a configuration of the vehicle 1. The vehicle 1 includes one or more sensors 310, one or more communication devices 320, ECU 330, and one or more actuators 340. The ECU 330 is configured to be able to communicate with the one or more sensors 310, the one or more communication devices 320, and the one or more actuators 340. Typically, each device is connected to an in-vehicle network configured by a controller area network (CAN) or the like.

The one or more sensors 310 include at least a camera that captures the surroundings of the vehicle 1. In addition, examples of the one or more sensors 310 include a sensor detecting surrounding environment of the vehicle 1 (a preceding vehicle, a road surface marking, an obstacle, or the like) and a sensor detecting a traveling state of the vehicle 1 (a vehicle speed, an acceleration, a yaw rate, or the like). The sensor detecting surrounding environment of the vehicle 1 is, for example, a millimeter wave radar, a LiDAR (light detection and ranging), or the like. The sensor detecting the traveling state of the vehicle 1 is, for example, a vehicle speed sensor, an accelerometer, a gyroscope, or the like. Information detected by the one or more sensors 310 is transmitted to the ECU 330.

The one or more communication devices 320 communicate with a device outside the vehicle 1 to transmit/receive information. In particular, the one or more communication devices 320 include a device for communicating with the management server 100 and the remote assistance apparatus 200 (typically, a device that performs wireless communication with a wireless base station). That is, the allocation status, the driving decision from the remote assistance operator 2, and the like are acquired by the one or more communication devices 320. In addition, examples of the one or more communication devices 320 include a device for communicating with peripheral vehicles, a GPS receiver, and the like. Information received by the one or more communication devices 320 is transmitted to the ECU 330. Examples of the information received by the one or more communication devices 320 include the allocation status and the driving decision from the remote assistance operator 2. In addition, the examples include map information, road traffic information, GPS position information, and the like.

The ECU 330 executes processes regarding various controls of the vehicle 1 based on acquired information and generate control signals. The ECU 330 include an autonomous driving ECU 331 and a vehicle control ECU 332.

The autonomous driving ECU 331 executes a process for autonomous driving of the vehicle 1. In particular, the autonomous driving ECU 331 executes a process of generating a driving plan based on information detected by the one or more sensors 310 and information received by the one or more communication devices 320. The vehicle control ECU 332 executes a process for generating control signals for the one or more actuators 340 such that the vehicle 1 performs desired operations. In particular, the vehicle control ECU 332 executes a process of generating control signals for causing the vehicle 1 to travel in accordance with the driving plan generated by the autonomous driving ECU 331. The control signals generated by the vehicle control ECU 332 are transmitted to the one or more actuators 340.

The one or more actuators 340 operate in accordance with the control signals transmitted from the ECU 330. Examples of the one or more actuators 340 include an actuator related to an operation of a power unit (an internal combustion engine, an electric motor, or the like), an actuator related to an operation of a brake mechanism, an actuator related to an operation of a steering mechanism, and the like. The one or more actuators 340 operate in accordance with the control signals, thereby realizing autonomous driving of the vehicle 1.

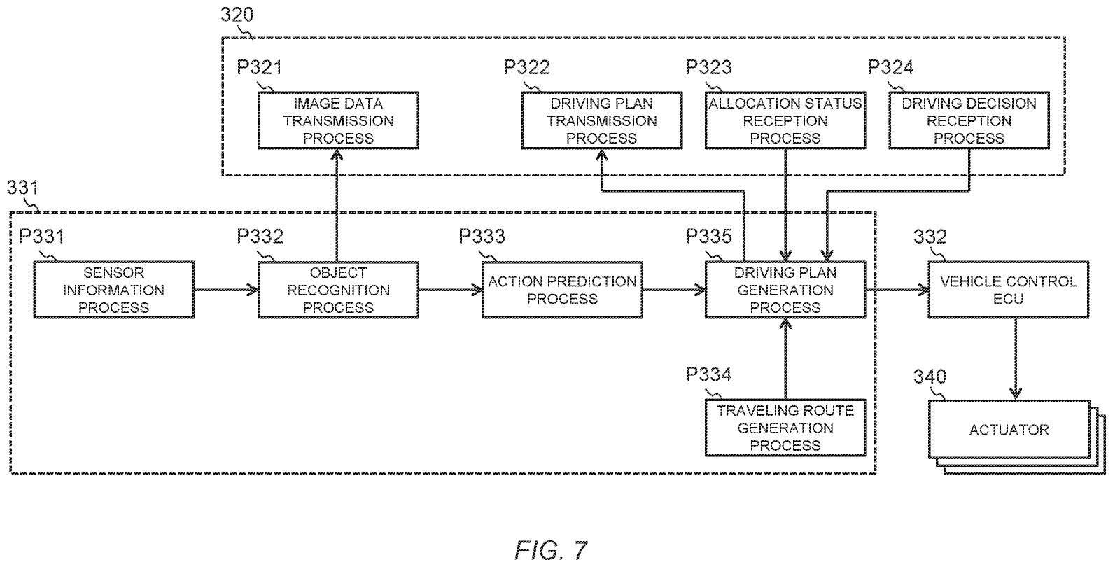

Next, a configuration of processes executed in the vehicle 1 according to the present embodiment will be described with reference to FIG. 7. The processes executed in the vehicle 1 is configured by an image data transmission process P321, a driving plan transmission process P322, an allocation status reception process P323, a driving decision reception process P324, a sensor information process P331, an object recognition process P332, an action prediction process P333, a traveling route generation process P334, and a driving plan generation process P335.

The sensor information process P331, the object recognition process P332, the action prediction process P333, the traveling route generation process P334, and the driving plan generation process P335 are executed in the autonomous driving ECU 331. And the image data transmission process P321, the driving plan transmission process P322, the allocation status reception process P323, and the driving decision reception process P324 are executed in the one or more communication devices 320.

The sensor information process P331 processes information acquired from the one or more sensors 310 and extracts information regarding objects around the vehicle 1.

The object recognition process P332 integrates the information regarding the objects around the vehicle 1 acquired from the one or more sensors 310, and determines types of the objects around the vehicle 1 (for example, person, vehicle, traffic light, ground, sky, and the like).

The action prediction process P333 predicts a moving path of each object around the vehicle 1.

The traveling route generation process P334 generates a traveling route to a destination. The traveling route may be information determining a route.

The driving plan generation process P335 determines a plurality of driving decisions (for example, lane change, start vehicle, stop vehicle, and the like) based on the result of the action prediction process P333 and the traveling route generated by the traveling route generation process P334. Then the driving plan generation process P335 generates a driving plan which is a combination of the plurality of driving decisions. In particular, the driving plan generation process P335 treats, as the assistance request item, a driving decision which the autonomous driving system is not good at. Furthermore, when acquiring the driving decision from the remote assistance operator 2, the driving plan generation process P335 updates the driving plan in accordance with the acquired driving decision.

The image data transmission process P321 transmits image data acquired from the camera provided in the vehicle 1 to the remote assistance apparatus 200. Here, the image data transmission process P321 may incorporate the recognition result of the objects around the vehicle 1 into the image data to be transmitted based on the result of the object recognition process P332. Alternatively, the image data transmission process P321 may be configured to transmit modeled information such as “a person is present at this position” based on the result of the object recognition process P332.

The driving plan transmission process P322 transmits the driving plan generated by the driving plan generation process P335 in response to one or more assistance request items being added to the plurality of driving decisions related to the driving plan.

The allocation status reception process P323 receives the allocation status of the plurality of remote assistance operators 2 from the management server 100.

The driving decision reception process P324 receives the driving decision from the remote assistance operator 2 through the remote assistance apparatus 200.

### 2-2. Management Server

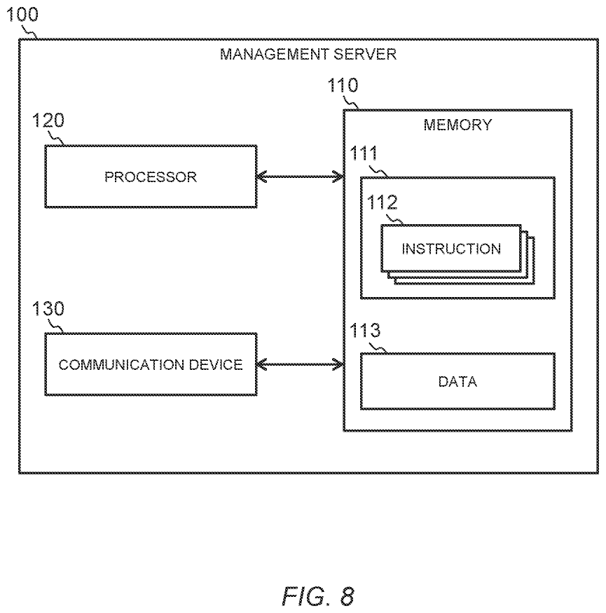

Next, a configuration of the management server 100 will be described. FIG. 8 is a block diagram showing a configuration of the management server 100. The management server 100 is a computer comprising a memory 110, a processor 120, and a communication device 130.

The memory 110 is coupled to the processor 120. And the memory 110 stores instructions 112 executable by the processor 120 and various data 113 required for executing processes. The instructions 112 are provided by a computer program 111. The computer program 111 may be recorded on a non-transitory computer readable medium included in the memory 110.

The instructions 112 are configured to cause the processor 120 to execute processes regarding the operator management function. That is, by the processor 120 operating in accordance with the instructions 112, executing processes regarding the operator management function is realized.

The communication device 130 communicates with a device outside the management server 100 to transmit/receive information. In particular, the communication device 130 communicates with the vehicle 1 and the remote assistance apparatus 200. That is, acquiring the remote assistance request and the assistance status is performed by the communication device 130. Also transmitting the allocation status and the assignment instruction is performed by the communication device 130. Information received by the communication device 130 is stored in the memory 110 as the data 113.

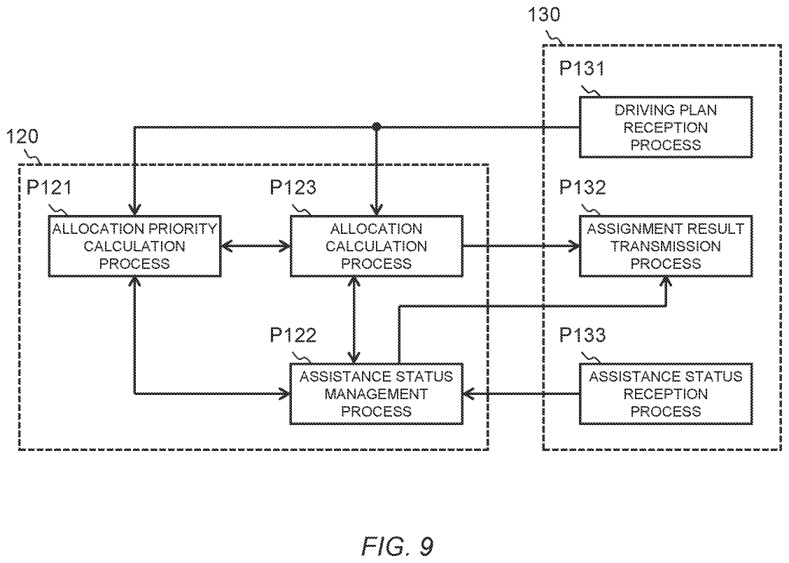

Next, a configuration of processes executed in the management server 100 according to the present embodiment will be described with reference to FIG. 9. The processes executed in the management server 100 includes an allocation priority calculation process P121, an assistance status management process P122, an allocation calculation process P123, an driving plan reception process P131, an assignment result transmission process P132, and a assistance status reception process P133.

The allocation priority calculation process P121, the assistance status management process P122, and the allocation calculation process P123 are executed by the processor 120 that operates in accordance with the instructions 112. The driving plan reception process P131, the assignment result transmission process P132, and the assistance status reception process P133 are executed by the communication device 130.

The allocation priority calculation process P121 calculates the allocation priority for each of the plurality of vehicles 1 based on the driving plan and the assistance status of the plurality of remote assistance operators 2. The calculation of the allocation priority is performed as described above. The allocation priority calculation process P121 may be configured to calculate the allocation priority when the management server 100 newly acquires the remote assistance request. Alternatively, the allocation priority calculation process P121 may be configured to calculate the allocation priority when a portion of one or more assistance request items is processed.

The assistance status management process P122 manages the assistance status of the plurality of remote assistance operators 2 in association with the allocation priority of each of the plurality of vehicles 1. That is, the assistance status management process P122 manages, for each of the plurality of remote assistance operators 2, what kind of remote assistance request of which vehicles 1 is being processed and the assignment priority of the vehicle 1 to be a target of remote assistance.

For example, the assistance status management process P122 manages a assistance status table as shown in Table 2 below as the data 113.

TABLE 2

| REMOTE | | | |
|---|---|---|---|
| ASSISTANCE | ASSISTANCE | ALLOCATION | VEHICLE |
| OPERATOR | REQUEST ITEM | PRIORITY | ID |
| @@@ | Lane change | 5 | 001 |
| *** | Lane change | 8 | 005 |
| | Crossing a sidewalk | | |
| | Adjustment of a | | |
| | parking position | | |

The allocation calculation process P123 calculates the assignment of the plurality of remote assistance operators 2 based on the assistance status of the plurality of remote assistance operators 2 and the allocation priority of each of the plurality of vehicles 1. The assignment of the plurality of remote assistance operators 2 is performed as described in FIGS. 3 to 5. The allocation calculation process P123 may be configured to calculate the assignment of the plurality of remote assistance request operators 2 when the management server 100 newly acquires the remote assistance request or when a portion of one or more assistance request items is processed.

The driving plan reception process P131 receives the driving plan transmitted by the vehicle 1.

The assignment result transmission process P132 transmits the assignment result to the vehicle 1 transmitting the remote assistance request (driving plan). The assignment result transmission process P132 may be configured to acquire the assignment result from the allocation calculation process P123. Furthermore, the assignment result transmission process P132 transmits, to the remote assistance apparatus 200, information (e.g., vehicle ID) for specifying the vehicle 1 to be assigned. The information for specifying the vehicle 1 may be acquired from the assistance status management process P122.

The assistance status reception process P133 receives the assistance status from each remote assistance apparatus 200 corresponding to each of the plurality of remote assistance operators 2.

### 2-3. Remote Assistance Apparatus

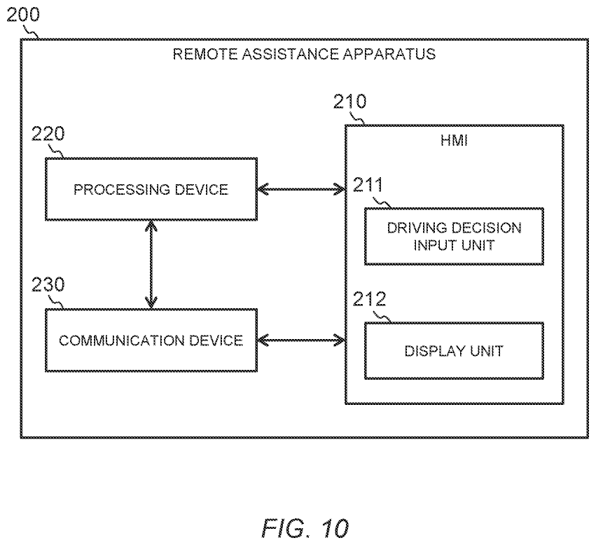

Next, a configuration of the remote assistance apparatus 200 will be described. FIG. 10 is a block diagram showing a configuration of the remote assistance apparatus 200. The remote assistance apparatus 200 comprises an HMI 210, a processing device 220, and a communication device 230.

The HMI 210 provides HMI (human machine interface) functionality for the remote assistance operator 2. The HMI 210 includes a driving decision input unit 211 and a display unit 212. The driving decision input unit 211 receives an input of a driving decision from the remote assistance operator 2. The driving decision input unit 211 is realized by, for example, a mouse, a keyboard, a touch panel, an operation panel, or the like. The display unit 212 displays information regarding the vehicle 1 to be a target of remote assistance. Typically, the display unit 212 displays image data of the surroundings of the vehicle 1 to be a target of remote assistance and information of the remote assistance request (driving plan) of the target vehicle 1. For example, the display unit 212 is realized by a display.

The remote assistance operator 2 confirms the situation of the vehicle 1 through the display of the display unit 212. Then, the remote assistance operator 2 input a driving decision for the remote assistance request by operating the driving decision input unit 211.

The processing device 220 is a computer that executes various processes based on acquired information. In particular, the processing device 220 executes a process for controlling display of the display unit 212.

The communication device 230 communicates with a device outside the remote assistance apparatus 200 to transmit/receive information. In particular, the communication device 230 communicates with vehicle 1 and the management server 100. That is, acquiring the assignment instruction is performed by the communication device 230. Also transmitting the driving decision from the remote assistance operator 2 and the assistance status are performed by the communication device 230. The information received by the communication device 230 is transmitted to the processing device 220.

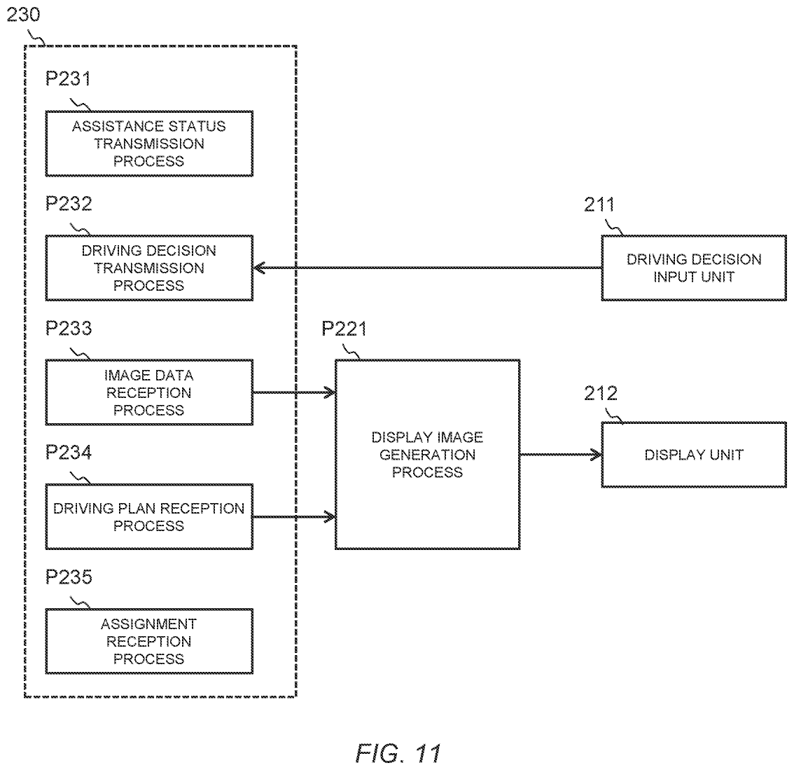

Next, a configuration of processes executed in the remote assistance apparatus 200 according to the present embodiment will be described with reference to FIG. 11. The processes executed in the remote assistance apparatus 200 includes a display image generation process P221, an assistance status transmission process P231, a driving decision transmission process P232, an image data reception process P233, a driving plan reception process P234, and an assignment reception process P235. Here, the display image generation process P221 is executed by the processing device 220. The assistance status transmission process P231, the driving decision transmission process P232, the image data reception process P233, the driving plan reception process P234, and the assignment reception process P235 are executed by the communication device 230.

The display image generation process P221 generates control signals for causing the display unit 212 to display an image based on the image date and the driving plan acquired from the vehicle 1 to be a target of remote assistance. The image generation processing unit P221 generates, for example, a control signal for displaying an image obtained by combining the acquired image data with information such as the predicted traveling trajectory, the assistance request item, and the position and size of surrounding objects. By displaying such an image, the remote assistance operator 2 can sufficiently check the situation around the vehicle 1 by confirming the display unit 212.

The assistance status transmission process P231 transmits the assistance status. The assistance status transmitted by the assistance status transmission process P231 may include information regarding an assistance request item which has not been processed yet for the vehicle 1 to be a target of remote assistance.

The driving decision transmission process P232 transmits the driving decision from the remote assistance operator 2 input through the driving decision input unit 211.

The image data reception process P233 receives image data from the target vehicle. The image data received by the image data reception process P233 may include recognition information regarding the surroundings of the vehicle 1 such as the positions and sizes of objects around the vehicle 1.

The driving plan reception process P234 receives the driving plan from the target vehicle.

The assignment reception process P235 receives information (e.g., vehicle ID) for specifying the vehicle 1 to be a target of remote assistance. In response to the reception of the vehicle ID by the assignment reception process P235, the remote assistance apparatus 200 starts remote assistance of the vehicle 1 specified by the vehicle ID. On the other hand, when the assignment reception process P235 does not receive the vehicle ID, the remote assistance operator 2 is assignable.

### 3. Process

The following will describe processes executed in the vehicle 1, the management server 100, and the remote assistance apparatus 200 in the operator management system 10 according to the present embodiment.

### 3-1. Autonomous Vehicle

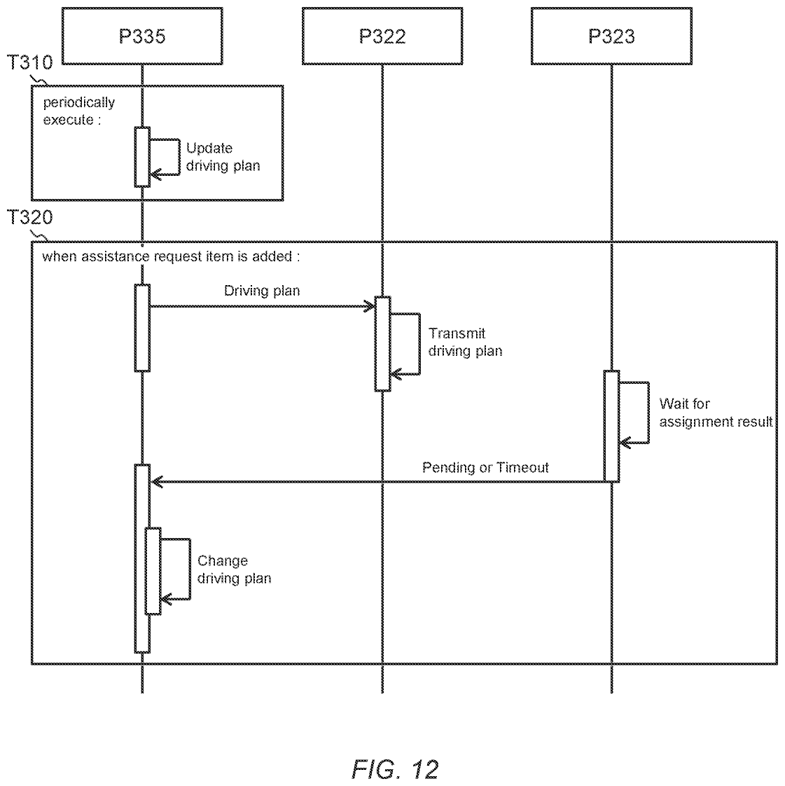

First, the processes executed in the vehicle 1 will be described. FIG. 12 is a sequence diagram showing the processes executed in the vehicle 1.

The driving plan generation process P335 periodically updates the driving plan based on the acquired information (T310).

When one or more assistance request items are added to the plurality of driving decisions related to the driving plan (T320), the driving plan transmission process P322 transmits the driving plan. Thereafter, the allocation status reception process P323 waits for reception of the assignment result.

When the allocation status reception process P323 receives the assignment result showing that the assignment of the remote assistance operator 2 is successful, the vehicle 1 starts communication with the remote assistance apparatus 200. Then, the driving decision reception process P324 waits for reception of the driving decision from the remote assistance operator 2 (not shown in FIG. 12).

On the other hand, when the allocation status reception process P323 receives the assignment result showing that the assignment of the remote assistance operator 2 is pending, or when the reception of the assignment result is not performed for a predetermined period and times out, the driving plan generation process P335 changes the driving plan. In this case, the driving plan generation process P335 may be configured to change the driving plan to one which can ensure safety and smooth traffic flow in the surroundings until the allocation is reperformed. For example, the driving plan generation process P335 changes the driving plan to one including low-speed traveling of the vehicle 1, stopping of the vehicle 1 at a road shoulder, and the like in the plurality of driving decisions. Alternatively, the driving plan generation process P335 may be configured to change a policy for generating an driving plan. For example, the driving plan generation process P335 changes the policy to generate a driving plan which emphasizes safety.

### 3-2. Management Server

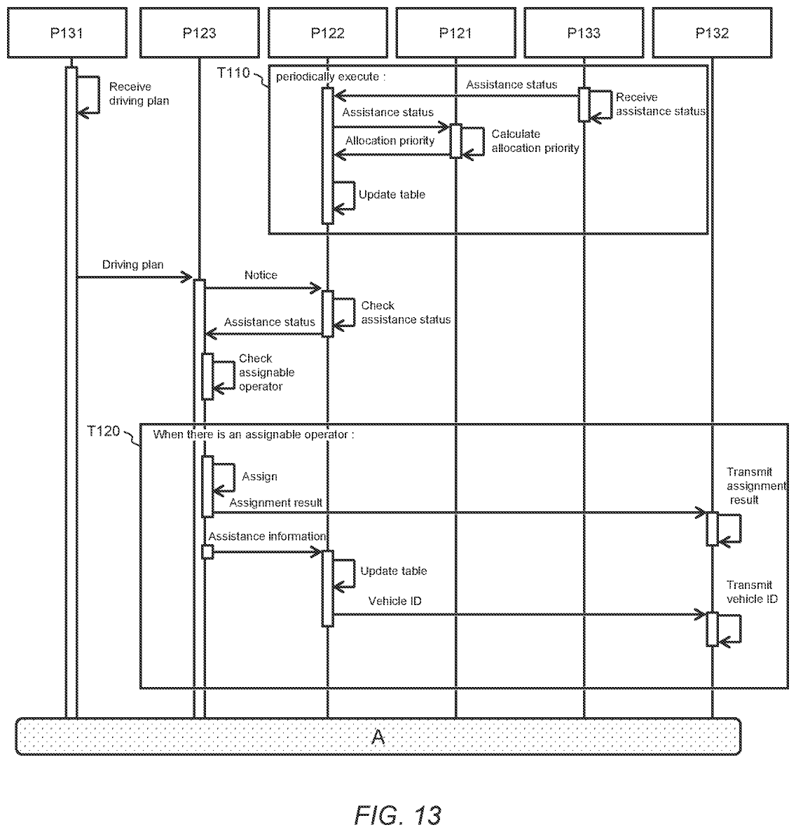

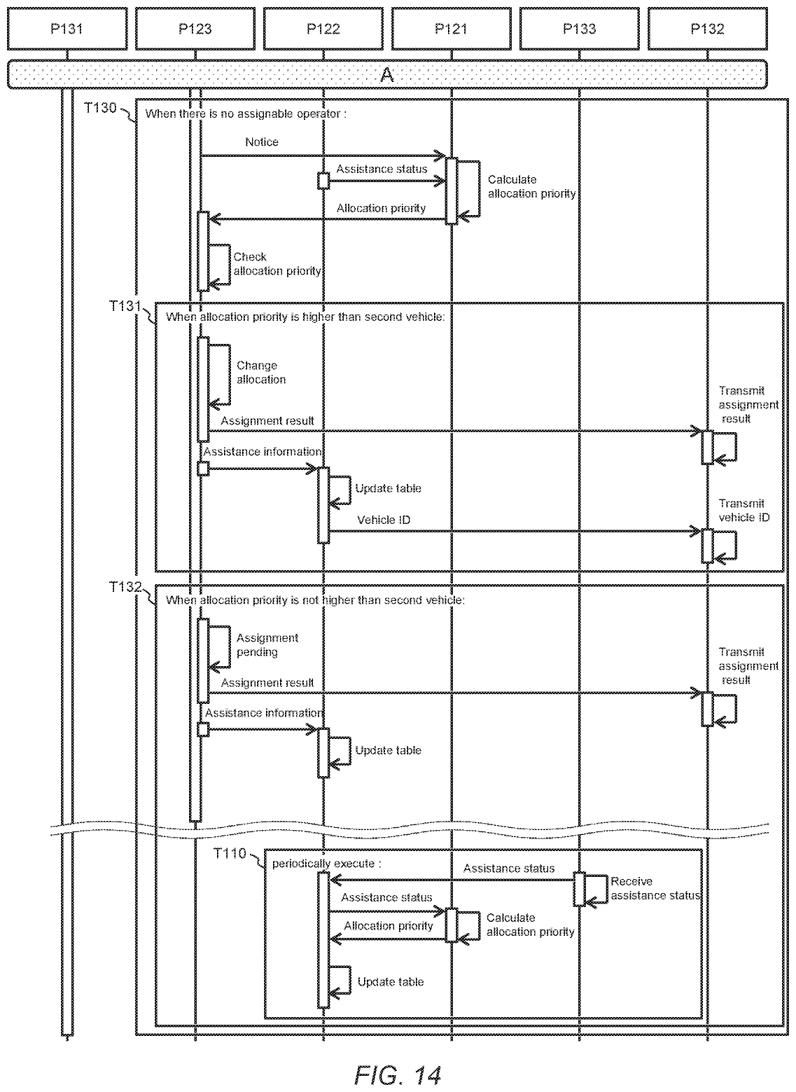

Next, the processes executed in the management server 100 will be described. FIGS. 13 and 14 are sequence diagrams showing the processes executed in the management server 100. Here, FIGS. 13 and 14 are connected by the position “A” and show one sequence diagram. In FIGS. 13 and 14, it is assumed that the assistance status management process P122 manages the assistance status of the plurality of remote assistance remote assistance operators 2 using the assistance management table as shown in Table 2.

The assistance status management process P122 periodically updates the assistance status table with respect to the allocation priority (T110). At this time, the assistance status management process P122 acquires the assistance status received by the assistance status reception process P133 and notifies the allocation priority calculation process P121 of the acquired assistance status. The allocation priority calculation process P121 calculates an allocation priority for each of the plurality of vehicles in response to reception of the notification of the assistance status. Then, the assistance status management process P122 updates the assistance status table based on the allocation priority calculated by the allocation priority calculation process P121.

The driving plan reception process P131, in response to reception of the driving plan (remote assistance request), notifies the allocation calculation process P123 of the received driving plan. The allocation calculation process P123, in response to the notification of the driving plan, acquires the assistance status from the assistance status management process P122. Then, the allocation calculation process P123 checks whether there is an assignable operator in the plurality of remote assistance operators 2.

When there is an assignable operator in the plurality of remote assistance operators 2 (T120), the allocation calculation process P123 assigns the available operator to the vehicle 1 which newly transmits the driving plan. Then, the allocation calculation process P123 notifies the assignment result transmission process P132 of an assignment result showing that the assignment of the remote assistance operator 2 is successful. The assignment result transmission process P132 transmits the notified assignment result to the vehicle 1. In addition, the allocation calculation process P123 notifies the assistance status management process P122 of information (assistance information) regarding the vehicle 1 to which the allocation is performed. The assistance information includes the vehicle ID, one or more assistance request items, and information regarding the assigned remote assistance operator 2. Further, the assistance information may include information regarding the allocation priority of the vehicle 1 to which the allocation is performed. In this case, the allocation priority calculation process P121 executes the process. The assistance status management process P122, in response to the notification of the assistance information, updates the assistance status table based on the assistance information. Then, the assistance status management process P122 notifies the assignment result transmission process P132 of the vehicle ID of the vehicle 1 to which the assignment is performed. The assignment result transmission process P132 transmits the informed vehicle ID to the remote assistance apparatus 200.

When there is no assignable operator in the plurality of remote assistance operators 2 (T130), the allocation calculation process P123 notifies the allocation priority calculation process P121. The allocation priority calculation process P121, in response to the notification, calculates the allocation priority of each of the plurality of vehicles 1 including the vehicle 1 which newly transmits the driving plan. Then, the allocation calculation process P123 checks the calculated allocation priority of each of the plurality of vehicles 1.

When the allocation priority of the vehicle 1 which newly transmits the driving plan is higher than the allocation priority of the second vehicle to which one of the plurality of remote assistance operators 2 is assigned (T131), the allocation calculation process P123 changes the allocation of the plurality of remote assistance operators 2 so as to assign the remote assistance operator 2 of the second vehicle to the vehicle 1 which newly transmits the driving plan. Thereafter, the allocation calculation process P123 notifies the assignment result transmission process P132 of the assignment result. Here, the assignment result notified by the allocation calculation process P123 shows, for the vehicle 1 which newly transmits the driving plan, that the assignment is successful. On the other hand, the assignment result shows, for the second vehicle, that the assignment will be out. The assignment result transmission process P132 transmits the notified allocation result to the vehicle 1 which newly transmits the driving plan and the second vehicle. In addition, the allocation calculation process P123 notifies the assistance status management process P122 of the assistance information regarding the vehicle 1 for which the assignment has been changed. The assistance status management process P122, in response to reception of the notification of the assistance information, updates the assistance status table based on the assistance information. Then, the assistance status management process P122 notifies the assignment result transmission process P132 of the vehicle ID of the vehicle 1 to which the assignment is performed. The assignment result transmission process P132 transmits the informed vehicle ID to the remote assistance apparatus 200.

When the allocation priority of the vehicle 1 which newly transmits the driving plan is equal to or lower than the allocation priority of the second vehicle to which one of the plurality of remote assistance operators 2 is assigned (T132), the allocation calculation process P123 suspends the assignment of the remote assistance operator 2 to the vehicle 1 which newly transmits the driving plan. Thereafter, the allocation calculation process P123 notifies the assignment result transmission process P132 of an assignment result showing that the assignment of the remote assistance operator 2 is pending. The assignment result transmission process P132 transmits the notified assignment result to the vehicle 1 which newly transmits the driving plan. In addition, the allocation calculation process P123 notifies the assistance status management process P122 of the assistance information regarding the vehicle 1 which newly transmits the driving plan. The assistance status management process P122, in response to the notification of the assistance information, updates the assistance status table based on the assistance information.

Thereafter, the assistance status management process P122 periodically updates the assistance status table with respect to the allocation priority (T110). When the number of the plurality of vehicles 1 is larger than the number of the plurality of remote assistance operators 2 (T130), a process related to T131 or T132 is performed on first vehicle to which any remote assistance operator 2 is not assigned and second vehicles to which one of the plurality of remote assistance operators 2 is assigned. That is, when the allocation priority of the first vehicle is higher than the allocation priority of the second vehicle, the remote assistance operator 2 of the second vehicle is allocated to the first vehicle.

In this way, the processes are executed in the management server 100. And by the management server 100 executing the processes described above, an operator management method for managing allocation of the plurality of remote assistance operators 2 to the plurality of vehicles 1 transmitting the remote assistance request. Furthermore, the computer program 111 (operator management program) causing the processor 120 to execute the processes described above is realized.

### 3-3. Remote Assistance Apparatus

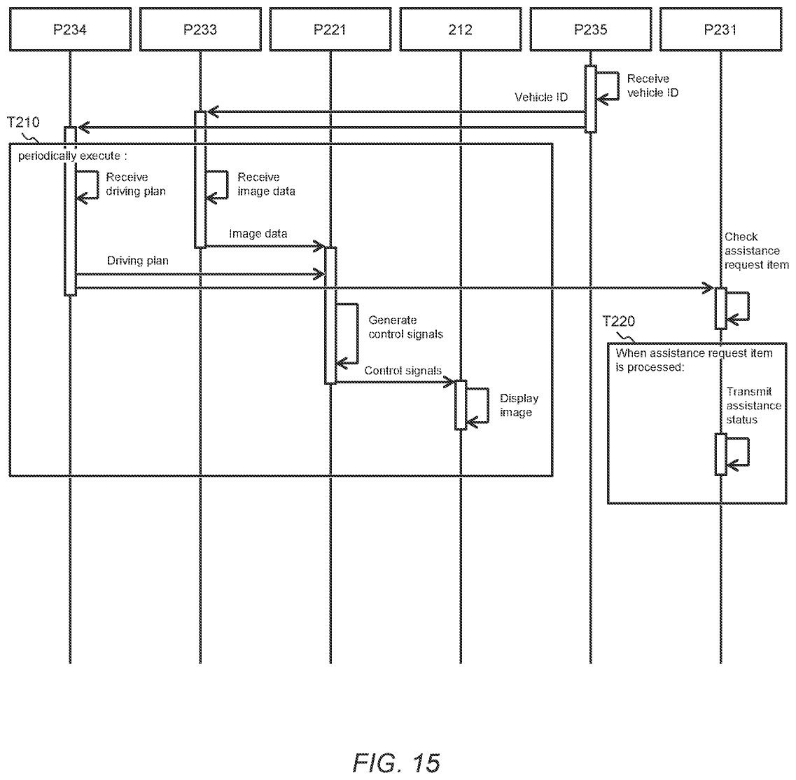

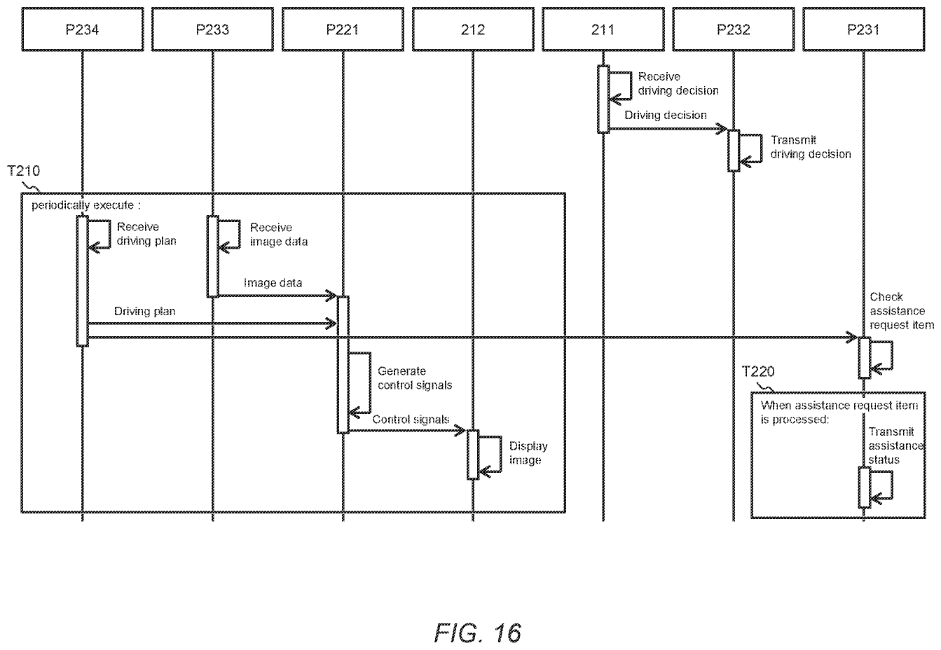

Next, the processes executed in the remote assistance apparatus 200 will be described. FIGS. 15 and 16 are sequence diagrams showing the processes executed in the remote assistance apparatus 200. FIG. 15 shows a process executed when the management server 100 assigns a remote assistance operator. FIG. 16 shows a process when the remote assistance operator 2 inputs a driving decision.

First, refer to FIG. 15. The remote assistance apparatus 200, in response to the assignment reception process P235 receiving the vehicle ID, starts communication with the vehicle 1 specified by the received vehicle ID. The assignment reception process P235 notifies the driving plan reception process P234 and the image data reception process P233 of the received vehicle ID.

While the remote assistance operator 2 is being assigned, the following processes is periodically executed (T210). The driving plan reception process P234 receives the driving plan from the vehicle 1 to be a target of remote assistance. Then, the driving plan reception process P234 notifies the received driving plan to the display image generation process P221 and the assistance status transmission process P231. The image data reception process P233 receives image data from the target vehicle. Then, the image data reception process P233 notifies the received image data to the display image generation process P221. The display image generation process P221 generates control signals based on the notified driving plan and the image data. Then, the display image generation process P221 notifies the display unit 212 of the control signals. The display unit 212 displays image in accordance with the notified control signals.

The assistance status transmission process P231, in response to the notification of the driving plan, checks the assistance request item related to the driving plan. Here, when the assistance request item is processed as a result of the remote assistance operator 2 inputting the driving decision, the driving plan is updated in the vehicle 1. That is, by checking the assistance request item related to the driving plan, it is possible to confirm whether or not the assistance request item is processed. When it is confirmed that the assistance request item has been processed (T220), the assistance status transmission process P231 transmits the assistance status.

Next, refer to FIG. 16. The driving decision input unit 211, when receiving the input of the driving decision from the remote assistance operator 2, notifies the received driving decision to the driving decision transmission process P232. The driving decision transmission process P232 transmits the notified driving decision to the target vehicle. The processes related to T210 and T220 is the same as the processes described in FIG. 15.

### 4. Effect

As described above, according to the present embodiment, the allocation priority is set or updated for each of the plurality of vehicles 1 in accordance with the contents of the remote assistance request. And when the number of the plurality of vehicles 1 is larger than the number of the plurality of remote assistance operators 2 and when the allocation priority of the first vehicle to which any remote assistance operator is not assigned is higher than that of the second vehicle to which one of the plurality of remote assistance operators 2 is assigned, the remote assistance operator 2 assigned to the second vehicle is assigned to the first vehicle. It is thus possible to assign the plurality of remote assistance operators 2 such that a vehicle having a high degree of urgency of remote assistance is preferentially processed. As a result, it is possible to appropriately assign the plurality of remote assistance operators 2 based on the viewpoint of speeding up emergency response, smoothing traffic flow, and the like.

### 5. Modification

The operator management system 10 according to the present embodiment may adopt the following modification.

The management server 100 may be configured to adjust, based on a some index, the allocation priority calculated based on the assistance priority. For example, the management server 100 may be configured to further multiply the allocation priority calculated based on the assistance priority by using the length of the period during which the remote assistance operator 2 is not assigned as an index. It is possible to make the allocation priority of the first vehicle higher as the period of no assignment is longer. Consequently, it is possible to avoid a situation where the assignment of the remote assistance operator 2 is never assigned.

As other indexes, it is also possible to adopt a narrowness of the road on which the vehicle 1 is located, a degree of deviation from the operation schedule, circumstances around the vehicle 1, or the like.

What is claimed is:

1. An operator management system for managing allocation of a plurality of remote assistance operators to a plurality of vehicles transmitting a remote assistance request, the operator management system comprising:
one or more processors; and
a memory storing executable instructions configured to cause the one or more processors to execute:
setting an allocation priority corresponding to contents of the remote assistance request for each of the plurality of vehicles; and
reassigning a remote assistance operator assigned to a second vehicle to a first vehicle when the number of the plurality of vehicles is larger than the number of the plurality of remote assistance operators and when the allocation priority of the first vehicle is higher than the allocation priority of the second vehicle, the first vehicle being one of the plurality of vehicles to which any remote assistance operator is not assigned, the second vehicle being one of the plurality of vehicles to which one of the plurality of remote assistance operators is assigned.

2. The operator management system according to claim 1,
wherein the setting the allocation priority includes updating the allocation priority for each of the plurality of vehicles in response to newly acquiring the remote assistance request.

3. The operator management system according to claim 1,
wherein the remote assistance request includes one or more assistance request items, and
the setting the allocation priority includes:
calculating an assistance priority for each of the one or more assistance request items; and
setting the allocation priority based on the assistance priority.

4. The operator management system according to claim 3,
wherein the setting the allocation priority includes updating the allocation priority in response to a portion of the one or more assistance request items being processed by the remote assistance operator.

5. The operator management system according to claim 4,
wherein each of the plurality of vehicles is an autonomous vehicle traveling in accordance with a driving plan which is a combination of a plurality of driving decisions, and
each of the plurality of vehicles is configured to transmit, as the remote assistance request, the driving plan in response to the one or more assistance request items being added to the plurality of driving decisions.

6. An operator management method for managing, by a computer, allocation of a plurality of remote assistance operators to a plurality of vehicles transmitting a remote assistance request, the operator management method comprising:
setting an allocation priority corresponding to contents of the remote assistance request for each of the plurality of vehicles; and
reassigning a remote assistance operator assigned to a second vehicle to a first vehicle when the number of the plurality of vehicles is larger than the number of the plurality of remote assistance operators and when the allocation priority of the first vehicle is higher than the allocation priority of the second vehicle, the first vehicle being one of the plurality of vehicles to which any remote assistance operator is not assigned, the second vehicle being one of the plurality of vehicles to which one of the plurality of remote assistance operators is assigned.

7. A non-transitory computer readable recording medium storing a computer program for managing allocation of a plurality of remote assistance operators to a plurality of vehicles transmitting a remote assistance request,
the computer program including executable instructions configured to cause one or more processors to execute:
setting an allocation priority corresponding to contents of the remote assistance request for each of the plurality of vehicles; and
reassigning a remote assistance operator assigned to a second vehicle to a first vehicle when the number of the plurality of vehicles is larger than the number of the plurality of remote assistance operators and when the allocation priority of the first vehicle is higher than the allocation priority of the second vehicle, the first vehicle being one of the plurality of vehicles to which any remote assistance operator is not assigned, the second vehicle being one of the plurality of vehicles to which one of the plurality of remote assistance operators is assigned.
